(19) United States
(12) Patent Application Publication
(10) Pub. No.: US 2017/0130661 A1
(43) Pub. Date: May 11, 2017

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Sho NAKAMURA, Susono-shi (JP)

(73) Assignee: TOYOTA JIDOSHA KABUSHIKI KAISHA, Toyota-shi (JP)

(21) Appl. No.: 15/341,394

(22) Filed: Nov. 2, 2016

(30) Foreign Application Priority Data
Nov. 6, 2015 (JP) 2015-218565

(51) Int. Cl. F02D 41/00; F02D 41/26

(52) U.S. Cl. CPC F02D 41/0077; F02D 41/0052; F02D 41/26; F02D 41/0002

(57) ABSTRACT

First calculation circuitry calculates a command value that is given to an actuator at each predetermined control period in accordance with a first control algorithm. Second calculation circuitry calculates a command value that is given to the actuator at each control period in accordance with a second control algorithm. The second control algorithm includes at least feed-forward control (FF control). When a control algorithm of the actuator is switched from the first control algorithm to the second control algorithm, the second calculation circuitry calculates a this-time value of the command value, with a value between a previous-time value of the command value calculated by the first calculation circuitry and a this-time value of FF control set as a corrected this-time value of the FF control, in an initial control period after switching.

### TECHNICAL FIELD

Embodiments of the present invention relate to a control device for an internal combustion engine.

### BACKGROUND

Patent Literature 1 discloses an art relating to EGR rate control of a diesel engine which is equipped with an EGR device. In this art, in the case of performing feedback control of both of an EGR valve and an intake throttle valve, the target opening degree of the intake throttle valve is also calculated constantly during feedback control by the EGR valve, and the actual valve opening degree of the intake throttle valve during this period is fixed to full opening.

### LIST OF RELATED ART

Following is a list of patent literatures which the applicant has noticed as related arts of embodiments the present invention.
Patent Literature 1: JP 2003-166445 A
Patent Literature 2: JP 59-188053 A
Patent Literature 3: JP 2015-14221 A
Patent Literature 4: JP 06-245576 A

### SUMMARY

Incidentally, in order to prevent degradation of emission, it is required to control the fresh air amount and the EGR rate of an internal combustion engine to target values with high precision by operating control valves such as an EGR valve and an intake throttle vale. In order to realize the request like this, it is indispensable to ensure control responsiveness and convergence of the control valves, and more specifically, it is required to ensure differential pressures between upstream pressures and downstream pressures of the control valves. However, in the above described conventional art, at the time of EGR rate control being switched from EGR rate control by the EGR valve to EGR rate control by the intake throttle valve, the intake throttle valve is kept at a fully opened state, that is, a state where a differential pressure between upstream pressure and downstream pressure of the intake throttle valve is low. Consequently, there is a fear that directly after EGR control by the intake throttle valve is started again, control responsiveness of the intake throttle valve cannot be ensured and the EGR rate cannot converge to a target value quickly.

As remedial measures against the problem as above, it is conceivable to apply a control algorithm which is different from the control algorithm for controlling the EGR rate, to control of the intake throttle valve, and calculate a command value to be given to the intake throttle value so that the differential pressure between upstream pressure and downstream pressure of the intake throttle valve becomes a target value, while the EGR rate control by the EGR valve is performed.

However, when a plurality of control algorithms with different state quantities of a control target (hereinafter, control state quantities) are selectively applied to a single actuator, there is a fear that the command value to the actuator abruptly changes before and after switching of the control algorithm. Especially when the control algorithm after switching includes feed-forward control (hereinafter, FF control), it is conceivable that a feed-forward term (hereinafter, an FF term) by the feed-forward control greatly deviates from the command value to the actuator directly before switching, in the initial control period at the time of the control state quantity being switched. In this case, it is conceivable that the command value to the actuator abruptly changes directly after switching, and controllability is reduced.

The present invention is made in the light of the aforementioned problem, and has an object to provide a control device for an internal combustion engine, which can prevent a command value that is given to an actuator from abruptly changing by switching of a control algorithm.

In accomplishing the above objective, according to a first embodiment of the present invention, there is provided a control device for an internal combustion engine, the control device comprising:

first calculation circuitry that calculates a command value that is given to an actuator of the internal combustion engine at each of predetermined control periods so that a first control state quantity becomes a target value in accordance with a first control algorithm;

second calculation circuitry that calculates a command value that is given to the actuator at each of the control periods so that a second control state quantity that is different from the first control state quantity becomes a target value in accordance with a second control algorithm; and

control algorithm switching circuitry that switches a control algorithm of the actuator between the first control algorithm and the second control algorithm,

wherein the second control algorithm includes feed-forward control, and

the second calculation circuitry is configured to calculate, in an initial control period after switching from the first control algorithm to the second control algorithm, a this-time value of the command value, with a value between a this-time value of the feed-forward control of the initial control period and a previous-time value of the command value calculated by the first calculation circuitry set as a corrected this-time value of the feed-forward control.

According to a second embodiment of the present invention, there is provided a control device for an internal combustion engine according to the first embodiment,

wherein the second calculation circuitry is configured to calculate the this-time value of the command value, with a value between the this-time value of the feed-forward control and a previous-time value of the feed-forward control set as the corrected this-time value of the feed-forward control until a predetermined control period from a next control period to the initial control period.

According to a third embodiment of the present invention, there is provided a control device for an internal combustion engine according to the first embodiment,

wherein the second control algorithm includes feedback control, and

the second calculation circuitry is configured to calculate a value which is obtained by adding a this-time value of a term that changes in accordance with a deviation of the feedback control to the corrected this-time value of the feed-forward control as the this-time value of the command value, in the initial control period.

According to a fourth embodiment of the present invention, there is provided a control device for an internal combustion engine according to the first embodiment,

wherein the internal combustion engine is a compression ignition type internal combustion engine, and the actuator is a throttle that is disposed in an intake passage of the internal combustion engine,

the first control algorithm is a control algorithm for calculating the command value which is given to the throttle so that a differential pressure between upstream pressure and downstream pressure of the throttle becomes a target differential pressure, and

the second control algorithm is a control algorithm for calculating the command value which is given to the throttle so that a fresh air amount passing through the throttle becomes a target fresh air amount.

According to a fifth embodiment of the present invention, there is provided a control device for an internal combustion engine according to the first embodiment,

wherein the internal combustion engine is a compression ignition type internal combustion engine, and the actuator is a throttle that is disposed in an intake passage of the internal combustion engine,

the first control algorithm is a control algorithm for calculating the command value which is given to the throttle so that a fresh air amount passing through the throttle becomes a target fresh air amount, and

the second control algorithm is a control algorithm for calculating the command value which is given to the throttle so that a differential pressure between upstream pressure and downstream pressure of the throttle becomes a target differential pressure.

According to a sixth embodiment of the present invention, there is provided a control device for an internal combustion engine according to the first embodiment,

wherein the internal combustion engine is a compression ignition type internal combustion engine, and the actuator is an EGR valve that is disposed in an EGR passage that connects an intake passage and an exhaust passage of the internal combustion engine,

the first control algorithm is a control algorithm for calculating the command value which is given to the EGR valve so that a differential pressure between upstream pressure and downstream pressure of the EGR valve becomes a target differential pressure, and

the second control algorithm is a control algorithm for calculating the command value which is given to the EGR valve so that an EGR rate of gas that is taken into a cylinder becomes a target EGR rate.

According to a seventh embodiment of the present invention, there is provided a control device for an internal combustion engine according to the first embodiment,

wherein the internal combustion engine is a compression ignition type internal combustion engine, and the actuator is an EGR valve that is disposed in an EGR passage that connects an intake passage and an exhaust passage of the internal combustion engine,

the first control algorithm is a control algorithm for calculating the command value which is given to the EGR valve so that an EGR rate of gas that is taken into a cylinder becomes a target EGR rate, and

the second control algorithm is a control algorithm for calculating the command value which is given to the EGR valve so that a differential pressure between upstream pressure and downstream pressure of the EGR valve becomes a target differential pressure.

According to the first embodiment of the present invention, in the initial control period after switching of the control algorithm, the this-time value of the command value is calculated, with the value between the this-time value of the feed-forward control and the previous-time value of the command value to the actuator, which is calculated by the first calculation circuitry set as the corrected this-time value of the feed-forward control. Consequently, according to this embodiment, a degree of change from the previous-time value of the command value to the this-time value of the feed-forward control is reduced, and therefore, the command value to the actuator can be effectively prevented from abruptly changing before and after switching of the control algorithm.

According to the second embodiment of the present invention, the value between the previous-time value and the this-time value of the feed-forward control is calculated as the corrected this-time value, until the predetermined control period from the next control period to the initial control period after switching of the control algorithm. Consequently, according to this embodiment, change from the previous-time value of the feed-forward control is restrained, and therefore, abrupt change of the command value of the actuator after switching of the control algorithm can be prevented.

According to the third embodiment of the present invention, the second control algorithm is configured by including feedback control. Further, according to this embodiment, the value between the this-time value of feed-forward control and the previous-time value of the command value calculated by the first calculation circuitry is set as the corrected this-time value of feed-forward control, and the value which is obtained by adding the this-time value of the term that changes in accordance with the deviation of the feedback control to the corrected this-time value of the feed-forward control as the this-time value of the command value, in the initial control period after switching of the control algorithm. When correction for slowing a change is applied to the term which changes in accordance with a deviation of feedback control, control followability is worsened. According to this embodiment, the this-time value of feed-forward control is corrected, and therefore it becomes possible to restrain a deviation of the control state quantity by feedback control and obtain favorable controllability while restraining the command value from abruptly changing before and after switching of the command algorithm to worsen controllability.

According to the fourth embodiment of the present invention, the first control algorithm is configured as a control algorithm for calculating the command value which is given to the throttle so that a differential pressure between upstream pressure and downstream pressure of the throttle becomes a target differential pressure. The second control algorithm is configured as a control algorithm for calculating the command value which is given to the throttle so that a fresh air amount passing through the throttle becomes a target fresh air amount. Consequently, according to this embodiment, abrupt change of the command value which is given to the throttle can be restrained, in the initial control period after the control state quantity is switched from the differential pressure between upstream pressure and downstream pressure of the throttle to the fresh air amount which passes through the throttle.

According to the fifth embodiment of the present invention, the first control algorithm is configured as a control algorithm for calculating the command value which is given to the throttle so that the fresh air amount passing through the throttle becomes the target fresh air amount, and the second control algorithm is configured as a control algorithm for calculating the command value which is given to the throttle so that the differential pressure between upstream pressure and downstream pressure of the throttle becomes the target differential pressure. Consequently, according to this embodiment, abrupt change of the command value which is given to the throttle can be restrained, in the initial control period after the control state quantity is switched from the fresh air amount which passes through the throttle to the differential pressure between upstream pressure and downstream pressure of the throttle.

According to the sixth embodiment of the present invention, the first control algorithm is configured as a control algorithm for calculating the command value which is given to the EGR valve so that a differential pressure between upstream pressure and downstream pressure of the EGR valve becomes the target differential pressure, and the second control algorithm is configured as the control algorithm for calculating the command value which is given to the EGR valve so that the EGR rate of the gas that is taken into the cylinder becomes the target EGR rate. Consequently, according to this embodiment, abrupt change of the command value which is given to the EGR valve can be restrained, in the initial control period after the control state quantity is switched from the differential pressure between upstream pressure and downstream pressure of the EGR valve to the EGR rate of the gas which is taken into the cylinder by switching of the control algorithm.

According to the seventh embodiment of the present invention, the first control algorithm is configured as a control algorithm for calculating the command value which is given to the EGR valve so that the EGR rate of the gas that is taken into the cylinder becomes the target EGR rate, and the second control algorithm is configured as a control algorithm for calculating the command value which is given to the EGR valve so that the differential pressure between upstream pressure and downstream pressure of the EGR valve becomes the target differential pressure. Consequently, according to this embodiment, the command value which is given to the EGR valve can be restrained from abruptly changing before and after switching, in the initial control period after the control state quantity is switched from the EGR rate of the gas which is taken into the cylinder to the differential pressure between upstream pressure and downstream pressure of the EGR valve by switching of the control algorithm.

### BRIEF DESCRIPTION OF DRAWINGS

FIG. 1 is a diagram showing a configuration of an engine system according to an embodiment of the present invention;

FIG. 2 is a diagram showing a control structure of a throttle operation of a control device according to the embodiment of the present invention;

FIG. 3 is a flowchart showing a routine of the throttle operation;

FIG. 4 is a diagram showing an example of an implementation region of throttle differential pressure control and fresh air amount control with respect to an operation state of an engine;

FIG. 5 is a graph group showing calculation results of example 1 and a comparative example to example 1; and

FIG. 6 is a graph group showing calculation results of example 2 and a comparative example to example 2.

### DETAILED DESCRIPTION

Hereinafter, an embodiment of the present invention will be described with reference to the drawings. Note that when the numerals of the numbers, the quantities, the amounts, the ranges and the like of the respective elements are mentioned in the embodiment shown as follows, the present invention is not limited to the mentioned numerals unless specially explicitly described otherwise, or unless the invention is explicitly specified by the numerals theoretically. Further, structures, steps and the like that are described in the embodiment shown as follows are not always indispensable to the present invention unless specially explicitly shown otherwise, or unless the invention is explicitly specified by them theoretically.

### 1. CONFIGURATION OF ENGINE SYSTEM

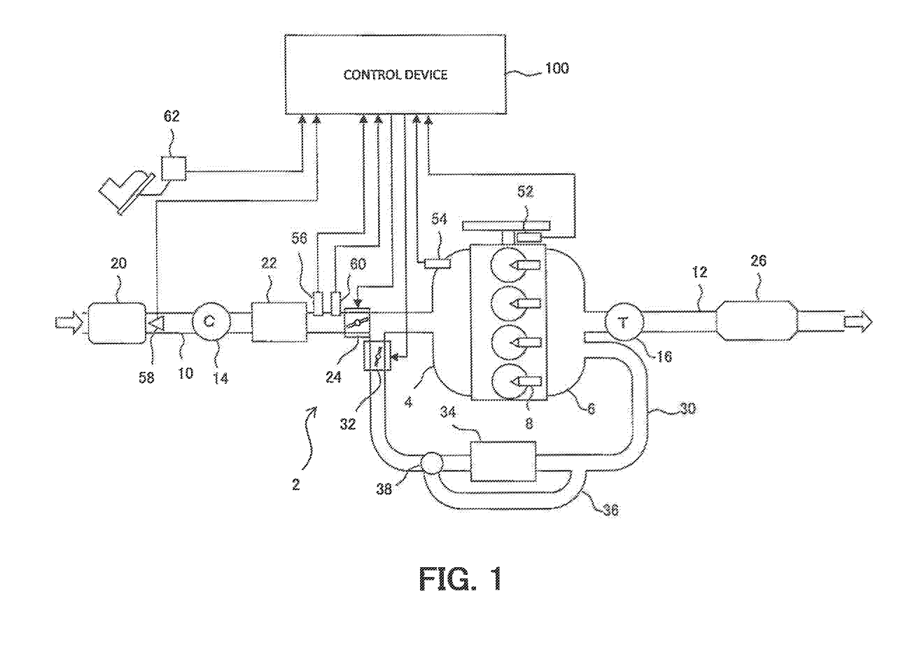

FIG. 1 is a diagram showing a configuration of an engine system of an embodiment of the present invention. An internal combustion engine of the present embodiment is a compression ignition type internal combustion engine (hereinafter, simply referred to as an engine) with a turbocharger. In an engine 2, four cylinders are provided in series, and an injector 8 is provided for each of the cylinders. An intake manifold 4 and an exhaust manifold 6 are mounted on the engine 2. An intake passage 10 in which air (fresh air) which is taken in from an air cleaner 20 flows is connected to the intake manifold 4. A compressor 14 of a turbocharger is mounted to the intake passage 10. In the intake passage 10, a throttle 24 is provided downstream of the compressor 14. In the intake passage 10, an intercooler 22 is provided between the compressor 14 and the throttle 24. An exhaust passage 12 for releasing exhaust gas into the atmosphere is connected to the exhaust manifold 6. A turbine 16 of the turbocharger is mounted to the exhaust passage 12. In the exhaust passage 12, a catalyst device 26 for purifying exhaust gas is provided downstream of the turbine 16.

The engine 2 is equipped with an EGR device for recirculating exhaust gas from an exhaust system to an intake system. The EGR device connects a position which is downstream of the throttle 24 in the intake passage 10 and the exhaust manifold 6 by an EGR passage 30. In the EGR passage 30, an EGR valve 32 is provided. An EGR cooler 34 is provided at an exhaust side with respect to the EGR valve 32 in the EGR passage 30. In the EGR passage 30, a bypass passage 36 that bypasses the EGR cooler 34 is provided. In a spot where the EGR passage 30 and the bypass passage 36 meet each other, a bypass valve 38 that changes a ratio of a flow rate of exhaust gas that flows through the EGR cooler 34 and a flow rate of the exhaust gas that flows through the bypass passage 36 is provided.

In the engine 2, sensors for obtaining information on an operation state of the engine 2 are provided at respective places. An air flow meter 58 for measuring a flow rate of fresh air that is taken into the intake passage 10 is attached downstream of the air cleaner 20 in the intake passage 10. A pressure sensor 56 and a temperature sensor 60 are attached to between the intercooler 22 and the throttle 24. A pressure sensor 54 is attached to the intake manifold 4. Further, a crank angle sensor 52 that detects rotation of a crankshaft, an accelerator opening degree sensor 62 that outputs a signal corresponding to an opening degree of an accelerator pedal and the like are also provided.

The aforementioned various sensors and actuators are electrically connected to a control device 100. The control device 100 is an ECU (Electronic Control Unit). The control device 100 performs control of an entire system of the engine 2, and is configured mainly by a computer including a CPU, a ROM and a RAM. In the ROM, routines of various kinds of control that will be described later are stored. The routines are executed by the control device 100, and the actuators are operated on the basis of signals from the sensors, whereby an operation of the engine 2 is controlled.

### 2. CONTENTS OF ACTUATOR OPERATION BY CONTROL DEVICE

The control device 100 operates the actuators by giving command values to the actuators. The command values to the actuators are calculated in accordance with predetermined control algorithms that are set for the respective actuators. Depending on the role of the actuator, a plurality of control algorithms may be selectively applied to the single actuator. In the engine 2 of the present embodiment, a plurality of control algorithms are applied to at least each of the throttle 24 and the EGR valve 32. When a plurality of control algorithms are applied to a single actuator, switching also occurs to a calculation method of a command value with switching of the control algorithm. If the calculation method changes, the command value is likely to change abruptly before and after switching. Consequently, in the control device 100, measures for preventing abrupt changes of the command values to the actuators at the time of the control algorithm being switched are prepared. Hereinafter, the measures will be specifically described for each of the actuators.

### 2-1. Throttle Operation

An operation of the throttle 24 is performed in throttle differential pressure control and fresh air amount control which will be described hereinafter.

### 2-1-1. Throttle Differential Pressure Control

Throttle differential pressure control is control which operates the throttle 24 so that a differential pressure between an upstream pressure and a downstream pressure of the throttle 24 (this will be referred to as a throttle differential pressure) becomes a target throttle differential pressure. The control state quantity in the throttle differential pressure control is the throttle differential pressure, and an operation amount is a closing degree of the throttle 24, in more detail, a closing degree to a fully opened position in a case where the fully opened position is set as a basic position. The control algorithm of the throttle differential control is configured by feed-forward control (hereinafter, FF control).

In the FF control of the throttle differential control, the closing degree of the throttle 24 which is a command value is calculated on the basis of the target throttle differential pressure, a fresh air amount (a present fresh air amount) measured by the air flow meter 58, a throttle upstream pressure measured by the pressure sensor 56, and a throttle upstream temperature measured by the temperature sensor 60. Calculation of the closing degree of the throttle 24 is performed by using a model formula (for example, a formula of throttle) of the throttle 24, or a map that is created on the basis of data obtained by adaptation. The operation of the throttle 24 by the throttle differential pressure control is carried out by being combined with an operation of the EGR valve 32 by EGR rate control which will be described later. The target throttle differential pressure is set so that a differential pressure necessary for EGR rate control is ensured between an upstream side and a downstream side of the EGR valve 32.

### 2-1-2. Fresh Air Amount Control

Fresh air amount control is control which operates the throttle 24 so that an amount of fresh air passing through the throttle 24 becomes a target fresh air amount. A control state quantity in the fresh air amount control is a fresh air amount, and an operation amount is the closing degree of the throttle 24. A control algorithm of the fresh air amount control is configured by FF control and feedback control (hereinafter, FB control).

In the FF control of the fresh air amount control, an FF term of the throttle closing degree is calculated on the basis of a target fresh air amount, a throttle upstream temperature which is measured by the temperature sensor 60, the throttle upstream pressure which is measured by the pressure sensor 56, an intake manifold pressure (a throttle downstream pressure) which is measured by the pressure sensor 54, and the fresh air amount (the present fresh air amount) which is measured by the air flow meter 58. Calculation of the FF term is performed by using the model formula of the throttle 24 (for example, the formula of throttle), or a map which is created on the basis of the data obtained by adaptation.

FB control of the fresh air amount control is PI control, where an FB term of the throttle closing degree is calculated on the basis of a deviation between the target fresh air amount and the present fresh air amount. The FB term is configured by a P term and an I term. FB control does not always have to be PI control, as long as FB control is control including either of I control and D control, and FB control may be PID control further including D control, for example.

In the fresh air amount control, a sum of the FF term and the FB term is set as a command value to the throttle 24. The target fresh air amount is determined from a map on the basis of a fuel injection amount and an engine speed. An operation of the throttle 24 by fresh air amount control is carried out by being combined with an operation of the EGR valve 32 by EGR valve differential pressure control which will be described later.

### 2-1-3. Control Structure for Throttle Operation

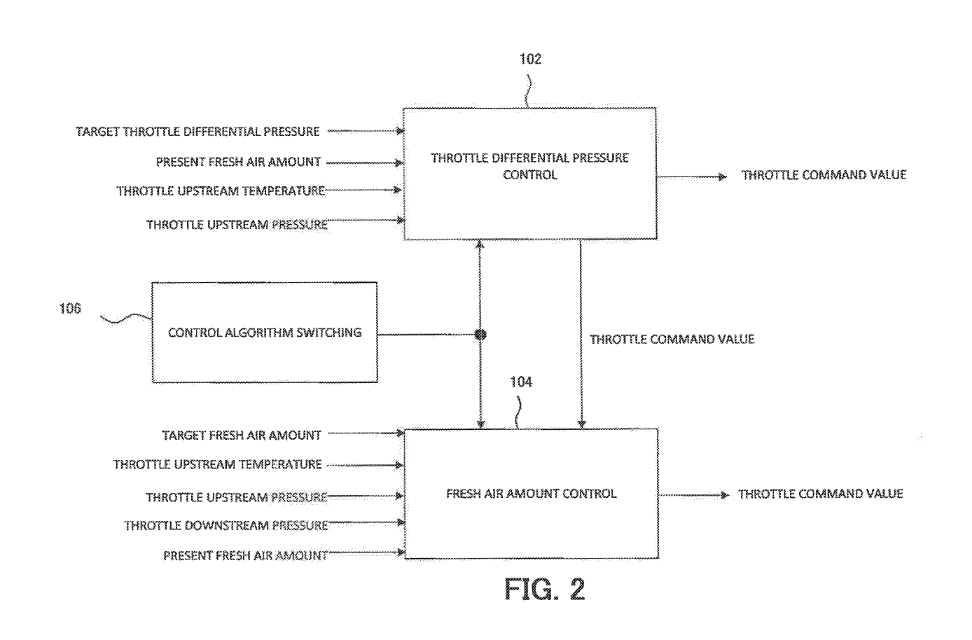

FIG. 2 is a block diagram showing a control structure of the control device 100 relating to the operation of the throttle 24. The control structure shown in FIG. 2 includes a throttle differential pressure control unit 102 as first calculation circuitry, a fresh air amount control unit 104 as second calculation circuitry, and a control algorithm switching unit 106 as control algorithm switching circuitry. The throttle differential pressure control unit 102 calculates a command value to the throttle 24 in accordance with the control algorithm of the aforementioned throttle differential pressure control. The fresh air amount control unit 104 calculates a command value to the throttle 24 in accordance with the control algorithm of the aforementioned fresh air amount control.

The control algorithm switching unit 106 selects a control algorithm which is applied to the throttle 24, and performs instruction to the throttle differential pressure control unit 102 and the fresh air amount control unit 104 in accordance with a selection result. When fresh air amount control is selected, the control algorithm switching unit 106 instructs the throttle differential pressure control unit 102 to stop calculation of the command value, and instructs the fresh air amount control unit 104 to start calculation of the command value. When the throttle differential pressure control unit 102 receives the instruction to stop calculation of the command value, the throttle differential pressure control unit 102 stops calculation of the command value and gives a newest command value to the fresh air amount control unit 104. When the fresh air amount control unit 104 receives the instruction to start calculation of the command value, the fresh air amount control unit 104 starts calculation of the command value by using the command value (a previous-time value of the command value) which is given by the throttle differential pressure control unit 102 only at an initial control period after switching. When throttle differential pressure control is selected, the control algorithm switching unit 106 instructs the fresh air amount control unit 104 to stop calculation of the command value, and instructs the throttle differential pressure control unit 102 to start calculation of the command value. In this case, transfer of the previous value of the command value is not performed between the throttle differential pressure control unit 102 and the fresh air amount control unit 104. Calculation of the command value at the time of switching the control algorithm will be described in detail later by using a flowchart.

The units 102, 104 and 106 which are included by the control device 100 correspond to a routine of the throttle operation which is stored in the ROM of the control device 100. The routine is read from the ROM and is executed by the CPU, whereby the functions of the units 102, 104 and 106 are realized in the control device 100.

### 2-1-4. Routine of Throttle Operation

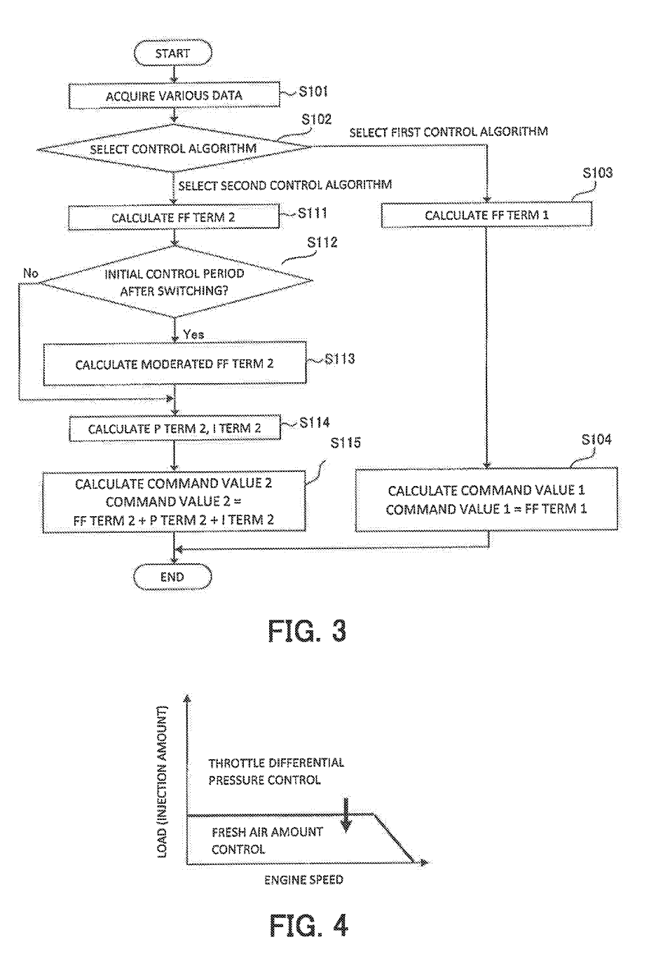

FIG. 3 is a flowchart showing the routine for realizing the functions of the units 102, 104 and 106 relating to the operation of the throttle 24 in the control device 100. The control device 100 executes the routine shown in FIG. 3 at constant control periods. Hereinafter, processing in the case of executing the routine will be described in sequence for each of steps. Note that in the following explanation, an actuator refers to the throttle 24. Further, a first control algorithm refers to a control algorithm of throttle differential pressure control, and a second control algorithm refers to a control algorithm of fresh air amount control.

In step S101, various data which are necessary to calculate command values in accordance with the respective control algorithms are acquired.

In step S102, based on the operation state of the engine 2, the control algorithm which is selected is determined. FIG. 4 is a diagram showing an example of implementation regions of the throttle differential pressure control and the fresh air amount control with respect to the operation state of the engine 2. In step S102, the control algorithm which is selected is switched from the first control algorithm to the second control algorithm, when the operation state of the engine 2 shifts from the region of the throttle differential pressure control at a high load side shown in FIG. 4 to the region of the fresh air amount control at a low load side. Conversely, when the operation state of the engine 2 shifts from the region of the fresh air amount control at the low load side to the region of the throttle differential pressure control, the control algorithm which is selected is switched from the second control algorithm to the first control algorithm.

When the first control algorithm is selected in the switching determination, steps S103 and S104 are executed as next processing. When the second control algorithm is selected in the switching determination, steps S111, S112, S113, S114 and S115 are executed, or steps S111, S112, S114 and S115 are executed, as next processing.

When the first control algorithm is selected, step S103 is executed first. In step S103, an FF term (an FF term 1) for FF control which is included in the first control algorithm is calculated.

In step S104, with use of the FF term (the FF term 1) which is calculated in step S103, a command value (a command value 1) which is given to the actuator is calculated by the following formula.

Command value 1=FF term 1 (1)

When the second control algorithm is selected, step S111 is executed first. In step S111, an FF term (an FF term 2) for FF control which is included in the second control algorithm is calculated.

In step S112, it is confirmed whether the control period of this time is an initial control period after switching of the control algorithm. Here, specifically, it is determined whether or not the control algorithm which is selected is switched from the first control algorithm to the second control algorithm in the processing in step S102 of the control period of this time. If the control period of this time is the initial control period after switching to the second control algorithm as a result, step S113 is executed first, and step S114 is executed next. Otherwise, however, step S113 is skipped, and step S114 is executed.

In step S113, out of the FF terms for FF control which are included in the second control algorithm, an FF term (a moderated FF term 2) which is used in only the initial control period after switching to the second control algorithm is calculated. Since in the initial control period after switching to the second control algorithm, the control state quantity is switched from the throttle differential pressure (the first control state quantity) to the fresh air amount (the second control state quantity), it is conceivable that the FF term 2 of the second control algorithm becomes a value that greatly deviates from the command value 1 of the first control algorithm directly before switching. The moderated FF term 2 refers to an FF term in which the deviation from the command value 1 is reduced by applying moderation correction to the FF term 2 as a countermeasure against the above, and corresponds to this-time value after correction of the embodiment of the present invention. Here, if it is calculation of ordinary moderation correction, the this-time value and a previous-time value of the FF term 2 are used, and calculation for reducing the deviation thereof can be performed. However, since calculation of the FF term 2 is performed after switching to the second control algorithm, there is no previous-time value of the FF term 2 in the initial control period after switching. Thus, in step S113, the moderated FF term 2 which is between a previous-time value of the command value 1 and the this-time value of the FF term 2 is calculated by using a command value (the previous-time value of the command value 1) calculated in step S104 in the control period of the previous time and the FF term 2 (the this-time value of the FF term 2) calculated in step S111 in the control period of this time, as in the following formulae, and the value is set as a this-time value of the FF term 2.

Moderated FF term 2=(this-time value of FF term 2−previous-time value of command value 1)×coefficient+previous-time value of command value 1 (2)

Coefficient=control period/(averaging time constant+control period),averaging time constant>0

According to formula (2) as above, 0<coefficient<1 is satisfied, and therefore the moderated FF term 2 becomes a value between the this-time value and the previous-time value of the command value 1. The formula for calculating the moderated FF term 2 is not limited to formula (2) as above. That is to say, as long as the formula is a formula for calculating the value which is between the previous-time value of the command value 1 and the this-time value of the FF term 2 by using the previous-time value of the command value 1 and the this-time value of the FF term 2, another known formula of moderation correction can be applied. Note that “between the previous-time value of the command value 1 and the this-time value of the FF term 2” mentioned here does not have meaning limited to a middle of the previous-time value of the command value 1 and the this-time value of the FF term 2, but widely includes values between these values.

Returning to explanation of the flowchart shown in FIG. 3 again, in step S114, a P term (a P term 2) for P control which is included in the second control algorithm, and an I term (an I term 2) for I control are respectively calculated by the following formulae. Note that “deviation” in each of the following formulae refers to a deviation between a target value and an actual value of the control state quantity (the fresh air amount in the case of the fresh air amount control). “deviation×I gain” is an updated amount of the I term. As for “the previous-time value of the I term 2”, the previous-time value is not present when step S113 is executed, so that zero which is a virtual previous-time value is used, and when step S113 is skipped, the I term which is calculated in step S114 in the control period of the previous time is used.

P term 2=deviation×P gain (3)

I term 2=deviation×I gain+previous-time value of I term 2 (4)

D term 2=derivative value of deviation×D gain (5)

In step S115, a command value (a command value 2) which is given to the actuator is calculated by the following formula by using the FF term (the FF term 2) which is calculated in step S111, and the FB term (the P term 2, the I term 2) calculated in step S114.

Command value 2=FF term 2+P term 2+I term 2 (6)

When step S113 is executed, that is, in the initial control period after switching from the first control algorithm to the second control algorithm, the command value (the command value 2) which is given to the actuator is expressed by the following formula resultantly.

Command value 2=moderated FF term 2+P term 2+I term 2 (7)

In formula (7) described above, the moderated FF term 2 is the value between the previous-time value of the command value 1 and the this-time value of the FF term 2. Consequently, the command value (the command value 2) which is calculated in the initial control period becomes the value closer to the previous-time value of the command value (the command value 1) than in the case where moderation correction is not performed for the FF term 2. Thereby, the command value which is given to the actuator is prevented from abruptly changing before and after switching of the control algorithm.

Incidentally, in the control structure of the control device 100 described above, calculation of the command value (the command value 2) using the FF term (the moderated FF term 2) for which moderation correction is performed is performed in the initial control period after switching to fresh air amount control from throttle differential pressure control. However, the above described control structure can be also applied to the initial control period after switching to throttle differential pressure control from fresh air amount control. In this case, in the control structure shown in FIG. 2, throttle differential pressure control can be applied to the unit 104 instead of fresh air amount control, whereas the fresh air amount control can be applied to the unit 102 instead of the throttle differential pressure control. The control device 100 can include a control structure for an EGR valve operation which will be described later, in addition to the control structure for the throttle operation described above.

Further, in the control structure of the control device 100 described above, the control algorithm (the first control algorithm) of the throttle differential pressure control is configured by FF control, and the control algorithm (the second control algorithm) of the fresh air amount control is configured by FF control and FB control. However, the configurations of these control algorithms are not limited to the control algorithms described above. That is, the first control algorithm may be configured to include either one of FF control and FB control, and the second control algorithm can be configured to include at least FF control. Further, when the first control algorithm or the second control algorithm includes FB control, the configuration of the FB control is not limited, and may be a configuration including any of the P term, I term and D term. When the second control algorithm is configured by only FF control, the command value 2 which is calculated in the initial control period is a value of the moderated FF term 2, and is a value closer to the previous-time value of the command value 1 than the command value 2 (that is, the FF term 2) in the case where moderation correction is not performed. Consequently, even when the second control algorithm is configured by only FF control, the command value which is given to the actuator is prevented from abruptly changing before and after switching of the control algorithm.

Further, in the control structure of the control device 100 described above, moderation correction may be also applied to the this-time value of the FF term 2 in the control periods of the next time to the initial control period after switching and the following times. In this case, when the control period of this time is not the initial control period after switching to the second control algorithm, in the processing in step S112 in FIG. 3, the moderated FF term 2 can be calculated in accordance with the following formula, for example. In the control periods of the next time to the initial control period after switching and the following times, the previous-time values of the FF term 2 are present, and therefore, the previous-time value of the command value 1 does not have to be used as in the above formula (2) in this case. Consequently, the formula in this case is a formula of ordinary moderation correction for calculating a value between the previous-time value and the this-time value of the FF term 2.

Moderated FF term 2=(this-time value of FF term 2−previous-time value of FF term 2)×coefficient+previous-time value of FF term 2 (8)

Coefficient=control period/(averaging time constant+control period),averaging time constant>0

According to formula (8) in the above, 0<coefficient<1 is satisfied, the moderated FF term 2 is a value between the this-time value and the previous-time value of the FF term 2. Calculation of the moderated FF term 2 shown in formula (8) may be configured to be always executed from the control period next to the initial control period, or may be limited to a time period from the next control period to a predetermined control period.

### 2-2. EGR Valve Operation

An operation of the EGR valve 32 is performed in EGR valve differential pressure control and EGR rate control which will be described as follows.

### 2-2-1. EGR Valve Differential Pressure Control

The EGR valve differential pressure control is control which operates the EGR valve 32 so that a differential pressure (this is referred to as an EGR valve differential pressure) between a pressure upstream of the EGR valve 32 and a pressure downstream of the EGR valve 32 becomes a target differential pressure. A control state quantity in the EGR valve differential pressure control is the EGR valve differential pressure, and an operation amount is an opening degree of the EGR valve 32, in more detail, an opening degree to a fully closed position in a case of the fully closed position being set as a basic position. A control algorithm of the EGR valve differential pressure control is configured by FF control.

In the FF control of the EGR valve differential pressure control, calculation of an FF term of the EGR valve opening degree is performed on the basis of an engine speed, and a fuel injection amount. Calculation of the FF term is performed by using a map that is created on the basis of data obtained by adaptation. As described above, an operation of the EGR valve 32 by the EGR valve differential pressure control is carried out by being combined with the operation of the throttle 24 by fresh air amount control.

### 2-3-2. EGR Rate Control

EGR rate control is control which operates the EGR valve 32 so that an EGR rate of gas that is taken into cylinders becomes a target EGR rate. A control state quantity in the EGR rate control is an EGR rate, and an operation amount is the opening degree of the EGR valve 32. A control algorithm of the EGR rate control is configured by FB control.

The FB control of the EGR rate control is PID control, where an FB term of the EGR valve opening degree is calculated on the basis of a deviation between the target EGR rate and a present EGR rate. The FB term is set as a command value to the EGR valve 32. As described above, an operation of the EGR valve 32 by the EGR rate control is carried out by being combined with the operation of the throttle 24 by the throttle differential pressure control.

An EGR rate is a ratio of an EGR gas amount per stroke to a total gas amount per stroke, and the EGR gas amount per stroke is a difference between the total gas amount per stroke and a fresh air amount per stroke. The total gas amount per stroke can be calculated from the engine speed, an intake manifold pressure and an intake manifold temperature. The fresh air amount per stroke can be calculated from a fresh air amount per hour that is measured by the air flow meter 58, and the engine speed. Consequently, the present EGR rate can be calculated from the fresh air amount which is measured by the air flow meter 58, the intake manifold pressure, the intake manifold temperature and the engine speed. Meanwhile, the target EGR rate is an EGR rate for obtaining a target fresh air amount, and the target fresh air amount is determined by the engine speed and the fuel injection amount. Consequently, the target EGR rate can be calculated from the engine speed, the fuel injection amount, the intake manifold pressure and the intake manifold temperature. However, calculation methods of the present EGR rate and the target EGR rate described above are only examples, and the present EGR rate and the target EGR rate may be calculated from a larger number of parameters, or may be simply calculated from a smaller number of parameters.

### 2-2-3. Control Structure for EGR Valve Operation

The control structure shown in FIG. 2 can be applied to the control structure for an EGR valve operation. The EGR valve differential pressure control includes FF control similarly to the fresh air amount control, so that in the control structure shown in FIG. 2, the EGR valve differential pressure control can be applied to the unit 104 instead of the fresh air amount control, and the EGR rate control can be applied to the unit 102 instead of the throttle differential pressure control.

### 2-2-4. Routine of EGR Valve Operation

The routine shown in FIG. 3 can be applied to a routine of the EGR valve operation. In this case, the actuator refers to the EGR valve 32. Further, the first control algorithm refers to a control algorithm of the EGR rate control, and the second control algorithm refers to a control algorithm of the EGR valve differential pressure control. However, since the EGR rate control does not include FF control, the FB term (the P term 1, and the I term 1, for example) can be calculated in step S103 by calculation processing similar to step S114, and the FB term can be calculated as the command value 1 (for example, command value 1=P term 1+I term 1) in step S104. Further, the EGR valve differential pressure control does not include FB control, and therefore, zero can be inputted to the FB term (the P term 2 and the I term 2, for example) in step S114.

Incidentally, in the control structure of the control device 100 described above, the control algorithm (the first control algorithm) of the EGR rate control is configured by FB control, and the control algorithm (the second control algorithm) of the EGR valve differential pressure control is configured by FF control. However, the configurations of these control algorithms are not limited to the above described configurations. That is, the first control algorithm may be configured to include either one of FF control and FB control, and the second control algorithm may be configured to include at least FF control. Further, when the first control algorithm or the second control algorithm includes FB control, the configuration of FB control is not limited, and may be configured to include any of the P term, I term and D term.

Further, when EGR rate control is configured to include FF control, EGR rate control may be applied to the unit 104 instead of fresh air amount control, and EGR valve differential pressure control may be applied to the unit 102 instead of throttle differential pressure control, in the control structure shown in FIG. 2.

### 3. EXAMPLES

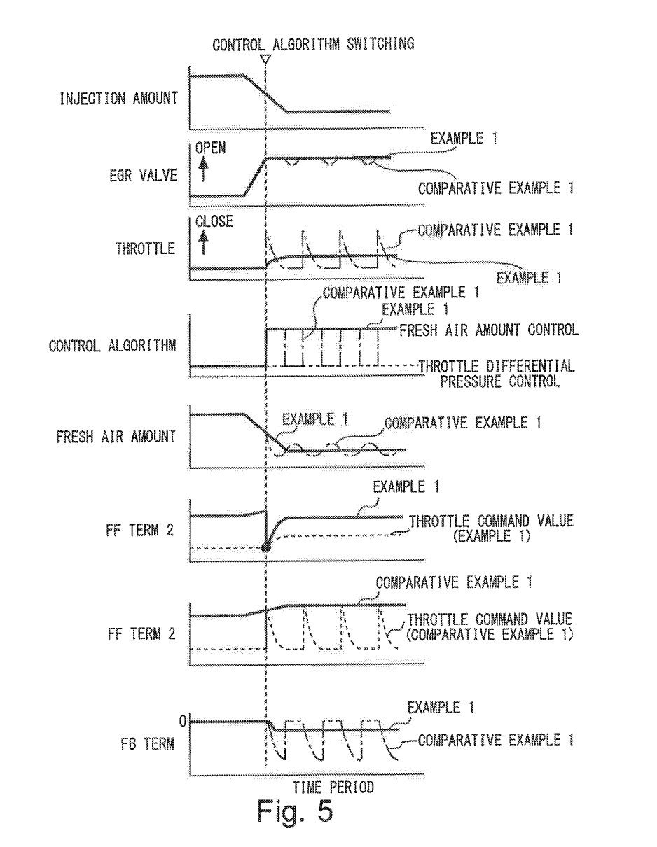

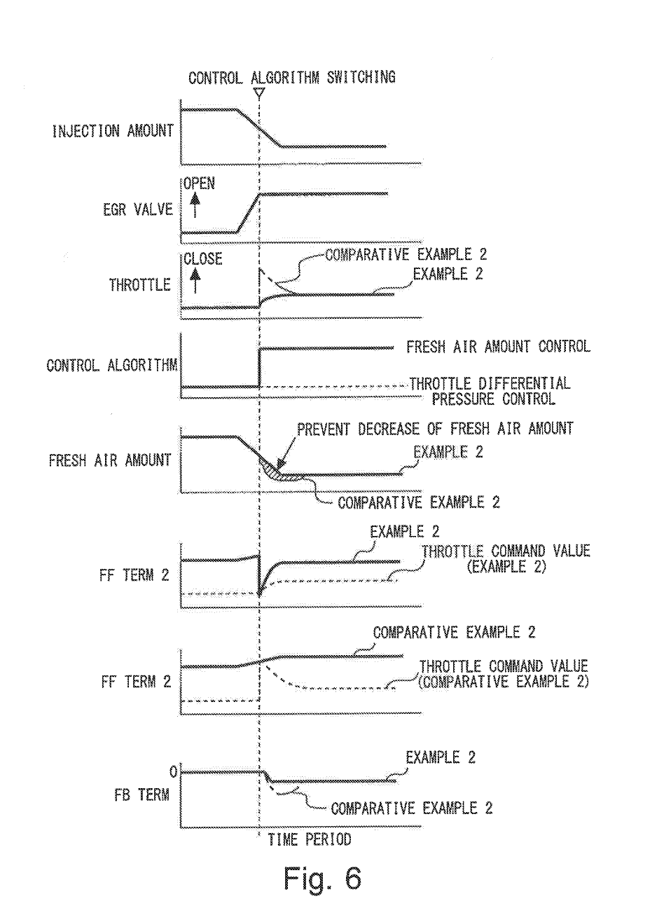

As specific examples of the present invention, FIG. 5 and FIG. 6 are presented.

### 3-1. Example 1

### 3-1-1. Outline of Example 1

In example 1, the present invention is applied to calculation of a command value in the case of switching the control algorithm relating to a throttle operation from throttle differential pressure control to fresh air amount control. In example 1 and comparative example 1, the control algorithm of throttle differential pressure control is configured by FF control, and the control algorithm of fresh air amount control is configured by FF control and FB control. Further, in the fresh air amount control in example 1 and comparative example 1, feedback gain (hereinafter, FB gain) of FB control is set at a large value and an influence of the FB term is enhanced.

FIG. 5 is a graph group showing calculation results of example 1 and comparative example 1 to example 1. In FIG. 5, first graph shows a behavior of an injection amount, second graph shows a behavior of an opening degree of the EGR valve, third graph shows a behavior of a closing degree of the throttle, fourth graph shows a switching behavior of the control algorithm, fifth graph shows a behavior of the fresh air amount, sixth graph shows behaviors of the FF term (the FF term 2) and a throttle command value in fresh air amount control in example 1, seventh graph shows behaviors of an FF term (an FF term 2) and a throttle command value in fresh air amount control of the comparative example, and eighth graph shows a behavior of an FB term, respectively.

### 3-1-2. Examination on Comparative Example 1

In comparative example 1 shown in FIG. 5, moderation correction is not applied to a this-time value of the FF term 2 in the initial control period after switching to fresh air amount control from throttle differential pressure control (seventh graph). Consequently, in the initial control period after switching, the throttle command value abruptly changes toward the this-time value of the FF term 2 (that is, in a closing direction). In this case, as shown in eighth graph, the FB term significantly corrects the command value to an opening direction to absorb abrupt change of the above described throttle command value, and therefore the throttle command value abruptly changes in the opening direction significantly (third graph). Thereby, the throttle command value is resurged more than necessary, and as a result, control is switched from fresh air amount control to throttle differential pressure control (fourth graph). As a result of the operation like this being repeated, hunting occurs to the throttle command value, and the fresh air amount does not converge to the target value (fifth graph).

### 3-1-3. Discussion on Example 1

In this relation, in example 1 shown in FIG. 5, the moderated FF term 2 which is calculated to be the value between the previous-time value of the command value and the this-time value of the FF term 2 is set as the this-time value of the FF term 2 in the initial control period after switching, in accordance with the processing in step S113 of the routine shown in FIG. 3.

According to example 1, the this-time value of the FF term 2 in the initial control period after switching becomes a value close to the throttle command value, and as a result, abrupt change of the throttle command value is restrained in the initial control period after switching (sixth graph). In this case, correction of the command value by the FB term is small as shown in seventh graph, and therefore, the subsequent throttle command value can be prevented from abruptly changing significantly to the opening direction (third graph). Thereby, it does not happen that hunting occurs to the throttle command value and control is switched to control of a different control algorithm (fourth graph), and therefore, the throttle command value also changes smoothly thereafter. As a result, the fresh air amount which is a control state quantity precisely follows the target value directly after switching of the control algorithm (fifth graph).

### 3-2. Example 2

### 3-2-1. Outline of Example 2

In example 2, the present invention is applied to calculation of a command value in the case of switching the control algorithm relating to a throttle operation from throttle differential pressure control to fresh air amount control as in example 1. In example 2 and comparative example 2, the control algorithm of throttle differential pressure control is configured by FF control, and the control algorithm of fresh air amount control is configured by FF control and FB control. However, in the fresh air amount control in example 2 and comparative example 2, FB gain of FB control is set at a value smaller than the value at the time of example 1 and an influence of the FB term is reduced.

FIG. 6 is a graph group showing calculation results of example 2 and comparative example 2 to example 2. In FIG. 6, first to eighth graphs respectively show behaviors similar to the behaviors of first to eighth graphs shown in FIG. 5.

### 3-2-2. Discussion on Comparative Example 2

In comparative example 2 shown in FIG. 6, moderation correction is not applied to a this-time value of the FF term 2 in the initial control period after switching to fresh air amount control from throttle differential pressure control (seventh graph). Consequently, in the initial control period after switching, the throttle command value abruptly changes toward the this-time value of the FF term 2 (that is, in a closing direction). In this case, as shown in eighth graph, the FB term corrects the command value to an opening direction to absorb the abrupt change of the above described throttle command value, but the throttle command value gradually changes to the opening direction because the FB gain is small (third graph). As a result that the change of the throttle command value is slow, a state where the fresh air amount is insufficient with respect to the target value continues, and a misfire and smoke occur (fifth graph).

### 3-2-3. Discussion on Example 2

In this relation, in example 2 shown in FIG. 6, the moderated FF term 2 which is calculated to be the value between the previous-time value of the command value and the this-time value of the FF term 2 is set as the this-time value of the FF term 2 in the initial control period after switching, in accordance with the processing in step S113 of the routine shown in FIG. 3.

According to example 2, the this-time value of the FF term 2 in the initial control period after switching becomes a value close to the throttle command value, and as a result, abrupt change to the closing direction of the throttle command value is restrained in the initial control period after switching (sixth graph). Since overshooting of the throttle command value to the closing direction is restrained as a result, the fresh air amount which is a control state quantity precisely follows the target value directly after switching of the control algorithm, and a misfire and smoke due to insufficiency of the fresh air amount are restrained (fifth graph).

### 4. OTHER MODIFICATION EXAMPLES

In the control structure of the control device 100 described above, as a mode of switching of the control algorithm, switching to fresh air amount control from throttle differential pressure control, or switching in the opposite way, and switching from EGR rate control to EGR valve differential pressure control or switching in the opposite way are described. However, control that is applicable to the control structure of the control device 100 is not limited to the above described combination, but may be any combination as long as it is the combination of control in which the control state quantity is switched to a different state quantity before and after switching.

1. A control device for an internal combustion engine, the control device comprising:
first calculation circuitry that calculates a command value that is given to an actuator of the internal combustion engine at each of predetermined control periods so that a first control state quantity becomes a target value in accordance with a first control algorithm;
second calculation circuitry that calculates a command value that is given to the actuator at each of the control periods so that a second control state quantity that is different from the first control state quantity becomes a target value in accordance with a second control algorithm; and
control algorithm switching circuitry that switches a control algorithm of the actuator between the first control algorithm and the second control algorithm,
wherein the second control algorithm includes feed-forward control, and
the second calculation circuitry is configured to calculate, in an initial control period after switching from the first control algorithm to the second control algorithm, a this-time value of the command value, with a value between a this-time value of the feed-forward control of the initial control period and a previous-time value of the command value calculated by the first calculation circuitry set as a corrected this-time value of the feed-forward control.

2. The control device for an internal combustion engine according to claim 1,
wherein the second calculation circuitry is configured to calculate the this-time value of the command value, with a value between the this-time value of the feed-forward control and a previous-time value of the feed-forward control set as the corrected this-time value of the feed-forward control until a predetermined control period from a next control period to the initial control period.

3. The control device for an internal combustion engine according to claim 1,
wherein the second control algorithm includes feedback control, and
the second calculation circuitry is configured to calculate a value which is obtained by adding a this-time value of a term that changes in accordance with a deviation of the feedback control to the corrected this-time value of the feed-forward control as the this-time value of the command value, in the initial control period.

4. The control device for an internal combustion engine according to claim 1,
wherein the internal combustion engine is a compression ignition type internal combustion engine, and the actuator is a throttle that is disposed in an intake passage of the internal combustion engine,
the first control algorithm is a control algorithm for calculating the command value which is given to the throttle so that a differential pressure between upstream pressure and downstream pressure of the throttle becomes a target differential pressure, and
the second control algorithm is a control algorithm for calculating the command value which is given to the throttle so that a fresh air amount passing through the throttle becomes a target fresh air amount.

5. The control device for an internal combustion engine according to claim 1,
wherein the internal combustion engine is a compression ignition type internal combustion engine, and the actuator is a throttle that is disposed in an intake passage of the internal combustion engine,
the first control algorithm is a control algorithm for calculating the command value which is given to the throttle so that a fresh air amount passing through the throttle becomes a target fresh air amount, and
the second control algorithm is a control algorithm for calculating the command value which is given to the throttle so that a differential pressure between upstream pressure and downstream pressure of the throttle becomes a target differential pressure.

6. The control device for an internal combustion engine according to claim 1,
wherein the internal combustion engine is a compression ignition type internal combustion engine, and the actuator is an EGR valve that is disposed in an EGR passage that connects an intake passage and an exhaust passage of the internal combustion engine,
the first control algorithm is a control algorithm for calculating the command value which is given to the EGR valve so that a differential pressure between upstream pressure and downstream pressure of the EGR valve becomes a target differential pressure, and
the second control algorithm is a control algorithm for calculating the command value which is given to the EGR valve so that an EGR rate of gas that is taken into a cylinder becomes a target EGR rate.

7. The control device for an internal combustion engine according to claim 1,
wherein the internal combustion engine is a compression ignition type internal combustion engine, and the actuator is an EGR valve that is disposed in an EGR passage that connects an intake passage and an exhaust passage of the internal combustion engine,
the first control algorithm is a control algorithm for calculating the command value which is given to the EGR valve so that an EGR rate of gas that is taken into a cylinder becomes a target EGR rate, and
the second control algorithm is a control algorithm for calculating the command value which is given to the EGR valve so that a differential pressure between upstream pressure and downstream pressure of the EGR valve becomes a target differential pressure.
